(19) United States
(12) Patent Application Publication
(10) Pub. No.: US 2010/0003182 A1
(43) Pub. Date: Jan. 7, 2010

(54) PELLITIZED SILICA

(76) Inventors: Lorenzo Costa, Sommo (IT); Björn Braun, Milano (IT)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/301,744

(22) PCT Filed: May 31, 2007
(86) PCT No.: PCT/EP07/55365

§ 371 Date: May 21, 2009

(30) Foreign Application Priority Data
Jun. 2, 2006 (EP) 2006/062883

(51) Int. Cl. C01B 33/12

(52) U.S. Cl. 423/338; 423/335

(57) ABSTRACT

Pelletized silica particles characterized by a round shape and a monomodal particle size distribution are produced by dispersing silica particles into water, adding water to the dispersion, mixing with alkoxisilane, pouring the mixture into an organic solvent, filtering and washing the silica particles obtained. The pelletized silica particles can be used to produce glass monoliths.

The subject of the invention is pelletized silica particles, the method to produces them and their use.

It is known how to produce quartz (silica) glass powder by hydrolyzing alkoxysilane at a specific pH to prepare a gel, powdering the gel, and after drying, calcining the powder (Japanese Patent Application Laid-open (KOKA1) No. 62-17 69 28 (1987)).

Furtheron it is known how to produce synthetic quartz glass powder by the following steps:
a) hydrolyzing an alkoxysilane to form a gel thereof
b) finely dividing the gel and then drying or drying the gel and then finely dividing to form a powder, and
c) calcining the powder of step b) (U.S. Pat. No. 5,516,350).

The particle size of the gel before the calcination step was adjusted to a diameter of 60 to 900 μm. The reference is silent about the particle size of the sintered quartz glass powder and the feature on its flowability.

Furtheron it is known how to produce a monolith silica glass article by the following steps:
hydrolyzing a silicon alkoxide in solution to form a hydrolyzed solution
adding an effective amount of fumed silica to the hydrolyzed solution to form a sol solution
gelling the sol solution to form a gel
drying the gel to form a dry gel and
sintering the dry gel to form a glass thereby to form a large monolithic silica glass article (U.S. Pat. No. 4,801,318)

This process does not produce a free flowing powder of synthetic quartz.

Furtheron it is known how to prepare inorganic oxide-based materials of spherical form with substantial monomodal distribution, by the following steps:
forming a sol of at least one of the inorganic oxides by hydrolyzing a tetraalkoxysilane
adding to said sol a solvent immiscible with the sol
finely dispersing the obtained two-phase mixture into a dispersion of particles of equal diameter
growing said particles by limited coalescence to the desired size and gelling said dispersion (of coalesced droplets) by adding a second solvent containing a gelling agent, and
removing the solvent.

The spherical material shows in the case of monomodal distribution a diameter between 1 nm and 1.000 nm. It can be used as a support for catalysts for the polymerization and copolymerization of olefinically unsaturated compounds (EP 0 537 850 A1).

Furtheron it is known how to prepare spherical silica particles by the following step:
(A) preparing a colloidal silica solution by hydrolyzing a silicon alkoxide on an aqueous media in the presence of mineral or organic acids
(B) possible dispersing fumed silica in the resulting colloidal silica solution
(C) mixing either the pure (step A) or the hybrid (step B) silica sol in an organic media constituted by monofunctional aliphatic alcohols R—OH or mixtures thereof
(D) emulsifying the so obtained mixture
(E) gelifying either the pure or the hybrid silica sol by bringing the previously obtained emulsion into contact with a basic solution
(F) heat treatment of the resulting gel

The spherical silica particles show a particle diameter within the range of from 10 to 100 micrometers (EP 0 653 378 A1).

The transportation, handling and storage of powder material is largely affected by the flowability and hardness of the particles, which consequently have a big commercial impact on the price and the quality of the final product. In particularly the efficiency of the mixing of powders could be strongly driven by the inhomogeneous particle size distribution, particles agglomeration and caking issues.

With the expression “free flowing powder composition” used throughout this specification is meant a powder (made by milling, micropelletizing, or similar technique) of which the particles consist of a composition as defined above and of which the particles do not adhere to one other. The size of the powder particles is expressed in terms of the particles diameter. In general, this size is determined by sieving and is independent of the shape of the particle.

On the contrary cohesive powder are those powders in which the cohesive forces among the particles are very important (strengthwise). As per definition a free flowing powder does not contains fines.

A conventional spray drying technique in which a spray dryer mixes a heated gas with an atomized (sprayed) liquid stream within a vessel (drying chamber) to accomplish evaporation and produce a free flowing dry powder with a controlled average particle size, is that available for instance by SDS Spray Drying Limited. With such spray drier it is possible to produce particle with averaged dimension of 300 micron with rather narrow particle size distribution.

Another even more elegant way to get the pelletization of metal oxides particles is to coat with chemicals like polymers or oils or waxes. In this case the properties of the granules are significantly changed for this reason very little is reported in the scientific literature.

Even though in the literature is reported a plethora of methods for the pelletization of metal oxides, at industrial level operation like: the mixing and the transportation, along i.e. moving belt or in pneumatic conveyors are still affected by the well known problems such as:
a) segregation: mainly due to differences on size of the particles, and to a minor extend differences in particle density. More in detail the forces that drive the segregation are: Van der Walls forces, electrostatic forces, liquid bridges, solid matter bridges and entanglement.
b) Percolation, during transit test granules with small sizes can gradually move under the bigger ones and thus leads to a separation of the differently sized particles.

When it comes to purity of the particle a major importance plays the silica. In fact nowadays there is a growing demand of silica with high purity grade for new high end applications, such as: the inner part of crucibles, optical fibers and components for microelectronics among the others. Unfortunately on the market there isn't a large availability of such a product, because of the very high costs and the very complex production procedures.

The subject of the invention are pelletized silica particles, which are characterized by a round shape and a monomodal particle size distribution.

Particles of silica according to the invention have the said silica as core with all around SiO₂ obtained via hydrolysis of liquid alkoxisilane.

Especially preferred the silica can be SiO₂ as fumed silica or natural quartz. The natural quartz can be i.e. JOTA 4 Type from JOTA Corporation and natural quartz from Norwegian Crystallites.

In a preferred feature of the invention the pelletized inorganic oxide particles the core can consist of natural quartz which is surrounded by silicondioxid, obtained via hydrolysis of liquid alkoxisilane. The alkoxisilane can be preferably tetraalkolisilane like tetraethoxy silane.

The said pelletized inorganic oxide particles according to the invention can be characterized by a surface area exceeding 50 m²/g.

The said pelletized inorganic oxide particles can have a size by which at least 90% are bigger than 100 micron. At least 90% of the pores can have a diameter lying between 50 and 1000 Angstrom.

Furthermore the alkoxisilane can be mixed with a soluble salt in order to obtained pelletized inorganic oxide particles doped with metals.

The free-flowing value is in the range from to more preferably from 5 to 2 according to the method developed by Degussa GmbH and published in the Technical Bulletin fine Particles Number 11 “Basic Characterisation of Aerosil Fumed silica. Powders with bad flow behavior have a mark 5 while powder with very good flow behavior are rated 1.

A further object of this invention is a method for the production of the pelletized silica particles having a round shape and a monomodal particle size distribution. According to the invention, which is characterized in that inorganic silica, to be palletized, is added under stirring in a vessel containing acidic water, when the dispersion is clearly homogeneous and without lumps liquid alkoxide silane such as i.e. tetramethoxysilane and/or tetraethoxysilane is then added very slowly to the mixture. As consequence of the exothermic reaction the temperature raises. The so obtained dispersion is then transferred slowly by means, for example, of a cannula in a vessel containing an organic solvent or a silicon oil previously mixed with an ammonia derivatives kept under strong stirring. The drops of silica dispersion in contact with the alkaline organic solution form gelly particles that are collected on the bottom of the reactor and then transferred to another vessel to be washed with an alcohol and/or an ester such as dioxane, propanol, acetone, ethanol or pure ethyl acetate among the others, finally the particles are then washed with acetone. The organic solvent or the silicon oil is then used for further runs. The particles are then filtered and then the solvent is extracted under supercritical or slightly subcritical conditions. Alternatively the solvent can be removed by control drying under controlled conditions (% humidity and T). The dried particles are then calcinated at high temperature with oxygen for at least 1 hour in order to eliminate traces of the solvents from the silica particles.

More in detail, it relates to a method for the production of silica particles out of powder with broad size distribution. The pelletization can be obtained by using sol-gel techniques which has been partially described in the EP 0 537 850 A1.

In a preferred subject of the invention the method can comprise the following features:

At room temperature an acid is added to water in a vessel until an acidic pH (2) is reached. Under strong stirring is then added the silica powder very slowly and afterwards the liquid siliconalkoxide like TEOS(Dynasil A from DEGUSSA AG). As consequence of the exothermic hydrolysis reaction the temperature rises of few degrees. The mixture is then kept under stirring for at least 20 minutes.

After vigorous stirring the solution is then poured in a vessel containing an organic solvent by means of a cannula. The pH is then risen by addition of an amine such as the Primene type supplied by Rohm and Haas, till very alkaline conditions are created, for example pH for 10% in water solution. The temperature further rises. The particles are then removed in continuous from the reaction batch and the obtained particles are then washed abundantly with water, in order to eliminate the residual solvent. The material so obtained is then calcinated in a vertical furnace at 600±150° C. for 6±2 hours in order to eliminate residual solvents.

The treated particles have a size in at least 90% of the particle have a size higher than 100 micron. The pelletization is obtained by using tetraethoxysilane as pelletizasing agent.

In case of pelletization of natural quartz powder is slightly different. At room temperature an acid is added to water in a vessel until a very acidic pH is reached (2). Under stirring the liquid siliconalkoxide like TEOS(Dynasil A from DEGUSSA AG) is added to the mixture, as consequence of the exothermic hydrolysis reaction the temperature rises of few degrees. Afterwards the natural quartz powder is then added to the mixture and then kept under stirring for at least 20 minutes.

After vigorous stirring the solution is then poured in a vessel containing an organic solvent kept under strong stirring. The pH is then risen by addition of an amine such as the Primene type supplied by Rohm and Haas, till very alkaline conditions are created, for example pH for 10% in water solution. The temperature further rises. The particles are then removed in continuous from obtained particles are then washed abundantly with water, in order to eliminate the residual solvent. The material so obtained is then calcinated in a vertical furnace at 600±150° C. for 6±2 hours in order to eliminate residual solvents.

Elsewhere the patents relates to a free flowing powder composition comprising hydrolyzed silica alkoxide like TEOS and metal oxides and/or a mixture of thereof.

Particles are characterized by the fact that there is an almost continuous phase between the pelletizing agent (the hydrolised silica alkoxide like TEOS) and the core material, since the pelletisating agent is able to impregnate the inorganic oxide particles.

The glassy particles obtained with this method according to the invention are characterized in terms of: flowability, microporosity and size distribution. Elsewhere, when the said inorganic oxide is silica or silica quartz the method allows to obtain a higher purity of the final product when compared to that of the starting particles. The purity increases approximately as direct function of the quantity of pelletizasing agent silica alkoxide like TEOS used.

The starting pH of the aqueous solution with inorganic oxide particles can be in the rage 1 to 4.

The liquid alkoxisilane can be tetramethoxysilane (CH₃O)₄Si and/or tetraethoxysilane (CH₃—CH₂—O)₄Si.

The organic solvent can be an apolar organic solvent, which has a dielectric constant lower than 60 at 20° C.

The salt to be added in order to obtain the doped silica particles can be inter alias, aluminum acetate, aluminum sulfate, aluminum ammonium sulfate, lead acetate, boric acid, ammonium fluoride sulfate, ammonium fluoride.

The apolar organic solvent can be a liquid alkane such as hexane, eptane, octane, nonane and alcohol such as: propanol, butanol, pentanol, hexanol, eptanol, octanol, nonanol, decanol and a aromatic compound like toluene, benzene, nitrobenzene, chlorobenzene, dichlorobenzene, quinoline, decaline and/or a mixture thereof.

Furtheron as organic solvent silicon oil can be used. The silicon oil can be polydimethylsiloxane fluids like Dimethicone from Wacker Chemie AG listed under the brand name Wacker AK 50.

The organic base ammonia derivative can be cyclohexylamine, t-alkyl amine.

The pH after the addition of the organic base can be in the range from 8 to 13, more preferably from 10 to 11 expressed as 10% water solution.

The calcinations temperature can be between 300 and 700° C. more preferably between 300 and 600°.

The pelletized silica particles are characterized by round shape and they are virtually without fines.

Analysis carried out on the pelletized silica particles showed that the method according to the invention allows obtain a monomodal distribution.

The microporosity and surface area of the material have been determined according to the method DIN 66131 by means of ASAP 2010 instrument from Micromeritics; measurements are carried out in liquid nitrogen.

Before the analysis, the material has been degassed at 300° C. for 4 h (P=1*10ex-6).

Flowability has been determined via an extremely simple, but nevertheless meaningful measurement method with viscosity vessels resembling hourglasses. When this method is employed, powder with good flow behavior still flow out of the glass vessels via a small discharge opening (see Degussa Aerosil Silanes Technical Bulletin Fine particle, page 56-57, 2005). When the powder/pellets flows only through the very big vessels it is consider a mark 5 while when the powder/pellets flows very easily even through a very thin vessel it has a mark of 1.

Solvents used to disperse the gelly particles during titration with ammonia derivatives are apolar, with dielectric constant not higher than 60. The list of tested solvents includes: alkane such as hexane, eptane, octane, nonane and alcohol such as: propanol, butanol, pentanol, hexanol, eptanol, octanol, nonanol, decanol and a aromatic compound like toluene, benzene, nitrobenzene, chlorobenzene, dichlorobenzene, quinoline and decaline.

The pelletized silica particles purity has been checked via ICP-MAS.

The pelletized silica particles, according to the invention can significantly raise the yield of transportation of the material by reducing the quantity of fines and narrowing the particle size distribution.

### EXAMPLE 1

At room temperature (19° C.) hydrochloric acid 37 Gew.-% conc., is added to 900 ml of water in a 4 l vessel till pH 2 is reached. Under stirring are then added very slowly 650 g of fumed silica, Aerosil EG50 supplied by Degussa, to be pelletized. When the dispersion is clear and homogeneous and without lumps, 650 g TEOS (Dynasil 40 from DEGUSSA AG) are then added very slowly to the mixture. As consequence of the exothermic hydrolysis reaction the temperature rises up to 24° C. After 1 hour of vigorous stirring the solution is then poured slowly dropwise by means of a cannula in a 22 l vessel containing 15 l of silicon oil (Wacker AK 50 from Wacker Chemie) mixed with a tertiary amine that had given a pH of 11 (expressed for a 10% water solution): Primene JM-T (supplied by Rohm and Haas). The temperature further rises up to 31° C. The emulsion containing the gelly particles is then filtered and the so obtained particle are then washed abundantly with water/acetone solution, in order to eliminate the residual silicon oil. The material so obtained is then calcinated in a vertical furnace at 600° C. for 8 hour in order to eliminate residual solvents.

### Characterization:

Particles size: The material is characterized by monomodal size distribution
   The averaged diameter is 430 micron
   Dimension of the starting material 3.7 micron
Porosity: Pores diameter 60 Angstrom, surface area 99 m2/g which is almost twice of the surface area of the starting material.

### Elemental Analysis:

Impurities in starting material (ppm):

### Na 1.6

### K 0.3

### Li 3.8

### Al 23

### Ca 0.5

### Fe 0.6

### Ti 2.4

### Co 0.01

### Cu 0.01

### Cr 0.02

Impurities in final material (ppm):

### Na 0.6

### K 0.05

### Li 3.0

### Al 12

### Ca 0.03

### Fe 0.01

### Ti 1.0

### Co <0.01

### Cu <0.01

### Cr <0.01

The pelletization improves greatly the dimension of the particles and its dispersion as well (monomodal distribution), not only, because the purity of the final material is much better than that of the starting particles.

Flowability: starting material mark is 5 while the palletized silica has a mark of 2, which means the pelletization process has improved the free flowing behavior.

### EXAMPLE 2

At room temperature (19° C.) hydrochloric acid 37 Gew.-% conc., is added to 900 ml of water in a 4 l vessel till pH 2 is reached. Under strong stirring 650 g Tetraethoxysilane (TEOS) (Dynasil 40 from DEGUSSA AG) are added very slowly to the mixture. After 20 minutes stirring are then added very slowly 650 g of natural quartz to be pelletized As consequence of the exothermic hydrolysis reaction the temperature rises up to 22° C. After 1 hour of vigorous stirring the solution is then poured dropwise in a 22 l vessel containing 15 l of silicon oil (Wacker AK 50 from Wacker Chemie). The pH is then risen by addition of a tertiary amine: Primene JM-T (supplied by Rohm and Haas), till pH 11 (10% water solution) is reached, that pH corresponds to a 10% w/w of Primene in silicon oil. The temperature further rises up to 31° C. The emulsion containing the gelly particles is then filtered and the so obtained particle are then washed abundantly with water, in order to eliminate the residual silicon oil. The material so obtained is then calcinated in a vertical furnace at 600° C. for 8 hour in order to eliminate residual solvents.

### Characterization:

Particles size: The material is characterized by monomodal size distribution
   The averaged diameter is 500 micron
   Dimension of the starting material 5.7 micron
Porosity: Surface area 74 m2/g which has to be compared with the almost undetectable low surface area of the natural quartz.

### Elemental Analysis:

Impurities in starting material (ppm):

### Na 1.9

### K 0.6

### Li 3.8

### Al 36.0

### Ca 1.0

### Fe 0.4

### Ti 3.2

### Co <0.001

### Cu 0.009

### Cr 0.03

Impurities in final material (ppm) before Calcination

### Na 2.0

### K 0.78

### Li 3.1

### Al 20

### Ca 1.7

### Fe 0.51

### Ti 3.2

### Co <0.01

### Cu <0.015

### Cr 0.43

Impurities in final material (ppm) after calcination:

### Na 0.9

### K 0.59

### Li 2.01

### Al 21.0

### Ca 3.40

### Fe 0.01

### Ti 2.9

### Co <0.01

### Cu <0.01

### Cr <0.02

The pelletization improves greatly the dimension of the particles and its dispersion as well (monomodal distribution), not only, because the purity of the final material is much better than that of the starting particles.

Flowability: starting material mark is 5 while the palletized natural quartz before the calcinations process has a mark of 4 whereas after the calcinations process the mark is between 2 and 3 which means that the pelletization process has improved the free flowing behavior.

### EXAMPLE 3

At room temperature (19° C.) hydrochloric acid 37 Gew.-% conc., is added to 900 ml of water in a 4 l vessel till pH 4 is reached. Under strong stirring 85 g of NH4F are dissolved and always under stirring are then added very slowly 585 g of fumed silica, Aerosil EG50 supplied by Degussa, to be pelletized. When the dispersion is clearly homogeneous without lumps 650 g TEOS (Dynasil 40 from DEGUSSA AG) are then added very slowly to the mixture. As consequence of the exothermic hydrolysis reaction the temperature rises up to 24° C. After 1 hour of vigorous stirring the solution is then poured very slowly and drop-wise in a 22 l vessel containing 15 l of silicon oil (Wacker AK 50 from Wacker Chemie). The pH of the silicon oil bath has been risen by addition of a tertiary amine:

Primene JM-T (supplied by Rohm and Haas), till pH 11 (10% water solution) is reached, that pH corresponds to a 10% w/w of Primene in silicon oil. The temperature further rises up to 31° C. The emulsion containing the gelly particles is then filtered and the so obtained particle are then washed abundantly with acetone/water solution, in order to eliminate the residual silicon oil. The material so obtained is then calcinated in a vertical furnace at 600° C. for 8 hour in order to eliminate residual solvents.

### Characterization:

Particles size: The material is characterized by monomodal size distribution
   The averaged diameter is 300 micron
   Dimension of the starting material 5.7 micron

1. Pelletized silica particles, having a round shape and a monomodal particle size distribution.

2. A method for the production of pelletized silica particles according to claim 1, comprising:
dispersing silica particles in water at acidic pH with stirring to form a dispersion, adding a liquid alkoxy-silane to the dispersion, transferring the so obtained dispersion with strong stirring to a vessel containing an organic solvent to form an aqueous solution, raising the pH by the addition of an organic base ammonia derivative to said vessel to obtain gelly particles, washing the obtained gelly particles with an alcohol and then with a mixture of an alcohol and water, filtering the particles to obtain inorganic oxide particles and then calcining the particles at high temperature for at least 1 hour in order to eliminate traces of the solvent from the inorganic oxide particles.

3. The method according to claim 2, wherein said silica is fumed silica.

4. The method according to claim 2, wherein the aqueous solution with silica particles has an initial pH in the range 1 to 4.

5. The method according to claim 2, wherein the silica is fumed silica.

6. The method according to claim 2, wherein the liquid alkoxysilane is tetramethoxysilane and/or tetraethoxysilane.

7. The method according to claim 2, wherein said organic solvent is an apolar organic solvent and has a dielectric constant lower than 60 at 20° C.

8. The method according to claim 2, wherein the aqueous solution contains a soluble salt as a doping agent for the pelletized silica.

9. The method according to claim 7, wherein said apolar organic solvent is a liquid alkane, silicon oil, alcohol or aromatic compound or mixtures thereof.

10. The method according to claim 2, wherein said ammonia derivative is cyclohexylamine or t-alkyl amine.

11. The method according to claim 2, further comprising raising the pH in the range from 8 to 12, by addition of base.

12. The method according to claim 2, wherein the calcining temperature is between 300 and 800° C.

13. A method for the production of pelletized natura quartz particles according to claim 1, comprising adding a liquid alkoxysilane to water at acidic pH with stirring to form an aqueous solution, and then with strong stirring adding natural quartz powder to the solution to obtain a dispersion, transferring the obtained dispersion with strong stirring to a vessel containing an organic solvent, then raising the pH by the addition of an inorganic base ammonia derivative to obtain gelly particles, washing the gelly particles with an alcohol and then with a mixture of an alcohol and water, filtering the particles and then calcining at high temperature for at least 1 hour in order to obtain inorganic oxide particles and to eliminate traces of the solvent from the inorganic oxide particles.

14. The method according to claim 13, wherein the solution with silica particles has a starting pH in the range 1 to 4.

15. The method according to claim 2, wherein the liquid alkoxysilane is tetramethoxysilane and/or tetraethoxysilane.

16. The method according to claim 13, wherein said organic solvent is an apolar organic solvent and has a dielectric constant lower than 60 at 20° C.

17. The method according to claim 13 where the aqueous solution contains a soluble salt as a doping agent for the pelletized natura quartz particles.

18. The method according to claim 13, wherein said apolar organic solvent is a liquid alkane, silicon oil, alcohol or aromatic compound and mixtures thereof.

19. The method according to claim 17, wherein said ammonia derivative is cyclohexylamine or t-alkyl amine.

20. The method according to claim 13, further comprising raising the pH in the range from 8 to 12 by addition of base.

21. The method according to claim 13, wherein the calcining temperature is between 300 and 800° C.

22. The method according to claim 7, wherein said organic solvent is a member selected from the group consisting of hexane, heptane, octane, nonane, silicon oil, propanol, butanol, pentanol, hexanol, heptanol, octanol, nonanol, decanol, toluene, benzene, nitrobenzene, chlorobenzene, dichlorobenzene, quinoline, decaline and mixtures thereof.

23. The method according to claim 13, wherein said organic solvent is a member selected from the group consisting of propanol, butanol, pentanol, hexanol, heptanol, octanol, nonanol, decanol, toluene, benzene, nitrobenzene, chlorobenzene, dichlorobenzene, quinoline, decaline and mixtures thereof.
